(19) United States
(12) Patent Application Publication
(10) Pub. No.: US 2024/0365792 A1
(43) Pub. Date: Nov. 7, 2024

(54) Pest Control Formulations and Uses Thereof

(71) Applicants: Sensorygen, Inc., South Pasadena, CA (US); THE REGENTS OF THE UNIVERSITY OF CALIFORNIA RIVERSIDE, Oakland, CA (US)

(72) Inventors: Anandasankar RAY, Riverside, CA (US); Joel KOWALEWSKI, South Pasadena, CA (US)

(21) Appl. No.: 18/688,482

(22) PCT Filed: Sep. 1, 2022
(86) PCT No.: PCT/US2022/042325

§ 371 Date: Mar. 1, 2024

Related U.S. Application Data
(60) Provisional application No. 63/239,632, filed on Sep. 1, 2021.

(51) Int. Cl. A01N 65/24; A01N 31/16; A01N 35/02; A01N 37/10; A01N 53/00; A01P 7/04

(52) U.S. Cl. CPC A01N 65/24; A01N 31/16; A01N 35/02; A01N 37/10; A01N 53/00; A01P 7/04

(57) ABSTRACT

The invention provides improved insecticide compositions comprising an insecticide and an arthropod repellent, an optional solvent, and/or their ingredients. The present invention also includes compositions methods of killing the insects.

### BACKGROUND OF INVENTION

Insects and other pests are common vectors for disease, often transferring parasites, viruses, and bacteria from reservoir hosts. They also cause enormous damage to agriculture crops and produce.

Mosquitoes in the genus Anopheles are the principle vectors of malaria, a disease caused by protozoa in the genus Trypanosoma. Aedes aegypti is the main vector of the viruses that cause Yellow fever, Dengue, Zika, and Chikungunya. Other viruses, the causal agents of various types of encephalitis, are also carried by Aedes spp. mosquitoes. Wuchereria bancrofti and Brugia malayi, parasitic roundworms that cause filariasis, are usually spread by mosquitoes in the genera Culex, Mansonia, and Anopheles.

Horse flies and deer flies may transmit the bacterial pathogens of tularemia (Francisella tularensis) and anthrax (Bacillus anthracis), as well as a parasitic roundworm (Loa loa) that causes Loa loa filariasis in tropical Africa.

Eye gnats in the genus Hippelates can carry the spirochete pathogen that causes yaws (Treponema pertenue), and may also spread conjunctivitis (pinkeye). Tsetse flies in the genus Glossina transmit the protozoan pathogens that cause African sleeping sickness (Trypanosoma gambiense and T. rhodesiense). Sand flies in the genus Phlebotomus are vectors of a bacterium (Bartonella bacilliformis) that causes Carrion's disease (Oroya fever) in South America. In parts of Asia and North Africa, sand flies spread a viral agent that causes sand fly fever (pappataci fever) as well as protozoan pathogens (Leishmania spp.) that cause leishmaniasis.

Most blood feeding insects, including mosquitoes, sandflies, Tsetse flies, use olfactory cues to identify human hosts. This group of hematophagous insects can transmit a wide assortment of deadly human diseases that together cause more suffering and deaths globally than any other disease condition. Diseases transmitted by such insects include malaria, dengue fever, yellow fever, West Nile virus, filariasis, river blindness, epidemic polyarthritis, leishmaniasis, trypanosomiasis, Japanese encephalitis, St. Louis encephalitis amongst others.

Climatic and social changes influence the distribution and the dynamics of mosquito-borne diseases thus contributing to the risk of emergence and resurgence of epidemics (malaria, dengue, chikungunya). For most mosquito-borne diseases, there is to date no vaccine and no curative treatment. The vector control and the prevention of mosquito bites are particularly based on the safe and efficacious use of chemicals. Because mosquitoes become resistant, it is essential to develop new strategies against insects to increase treatment efficacy and to circumvent resistance mechanisms.

Insect infestations also represent a major threat to economically important agricultural crops. The yield of plants, for example, cereals, citrus, cucurbitaceae, fibre plants, fruits, leguminous plants, ornamentals and vegetables, are significantly adversely impacted by insect attack. Yearly, plant pests cause over $100 billion dollars in crop damage in the U.S. alone. In an ongoing seasonal battle, farmers must apply billions of gallons of synthetic pesticides to combat these pests.

Chemicals that have been classically used up to now are classified into two main categories, according to their mode of action: in the first category are pest repellent molecules, which discourage pests from approaching an area or space, and in the second category are pesticide molecules that kill or incapacitate the pest.

Carbamates are a known class of insecticidally active compounds. Examples of carbamate insecticides are alanycarb, aldicarb, aldoxycarb, allyxycarb, aminocarb, bendiocarb, benfuracarb, bufencarb, butacarb, butocarboxim, butoxycarboxim, carbanolate, carbaryl, carbofuran, carbosulfan, cloethocarb, CPMC, decarbofuran, dicresyl, dimetan, dimethacarb, dimetilan, dioxacarb, EMPC, ethiofencarb, fenethacarb, fenobucarb, furathiocarb, hyquincarb, isolan, isoprocarb, methiocarb, methomyl, metolcarb, mexacarbate, nitrilacarb, oxamyl, pirimicarb, promacyl, promecarb, propoxur, pyramat, pyrolan, tazimcarb, thiocarboxime, thiodicarb, thiofanox, trimethacarb, XMC and xylylcarb.

Pyrethroids are known insecticides and are synthesized derivatives of naturally occurring pyrethrins, which are taken from pyrethrum, the oleoresin extract of dried chrysanthemum flowers. Ketoalcoholic esters of chrystanthemic and pyrethroic acid account for the insecticidal properties of pyrethrins. These acids are lipophilic and penetrate insects and paralyze their nervous system. The insecticidal action of pyrethroid is widely known to be effective against a variety of insect pests in many major crops such as fruits, vegetables, cereals, maize, cotton, soybean, grapes and even on public and animal health sectors. The activity of pyrethroids is both contact and stomach action as a broad spectrum insecticides. Examples of synthetic pyrethroids are deltamethrin, lambda-cyhalothrin, fenvalerate, permethrin, cypermethrin, bifenthrin, esfenvalerate, etofenprox, cyfluthrin, fenpropathrin, allethrin, cyphenothrin, flucythrinate, flumethrin, imiprothrin, metofluthrin, prallethrin, resmethrin, silafluofen, sumithrin, tefluthrin, tetramethrin, tralomethrin and transluthrin.

Synthetic insecticides often are non-specific and therefore can act on organisms other than the target ones, including beneficial organisms. They may be also toxic and non-biodegradable. Consumers are increasingly conscious of the potential environmental and health problems associated with the residuals of chemicals, particularly in food products. This has resulted in growing consumer pressure to reduce the use or at least the quantity of chemical (i.e., synthetic) pesticides.

A further problem arising with the use of synthetic pesticide is that the repeated and exclusive application of a pesticide often leads to selection of resistant microorganisms. Normally, such strains are also cross-resistant against other active ingredients having the same mode of action. An effective control of the pests with said active compounds is then not possible any longer.

Therefore, there is an urgent need to develop new pest control compositions and strategies. It nevertheless remains important that these compositions have pest-specific activity, owing to active ingredients targeting one or few evolutionarily conserved neural receptors. Pyrethroids target voltage-gated sodium channels. Though these channels are highly conserved, pyrethroids target specific sites on the sodium channel, and there are now variants of the channel among pests that are pyrethroid-resistant. One alternative strategy is to develop compositions that broadly interfere with the voltage-gated sodium channel in pests and not humans. This ensures safety and limits resistance. There are currently compounds that are known to target voltage-gated sodium channels in pests and many more that target the family of voltage-gated sodium channels in humans, discovered primarily using in vitro analyses.

Other methods employ delivering insecticidal activity by microorganisms or genes derived from microorganisms expressed in transgenic plants. For example, certain species of microorganisms of the genus Bacillus are known to possess pesticidal activity against a broad range of insect pests including Lepidoptera, Diptera, Colcoptera, Hemiptera, and others. However, these methods are also not without their limitations.

Repellent compounds range from naturally occurring extracts to commercially manufactured compounds. The degree of protection, duration of protection, and safety of these odors varies greatly. The gold standard of these compounds is generally considered to be DEET (N,N-diethyl-3-methylbenzamide, previously named N,N-diethyl-m-toluamide). Other known insect repellents are Icaridin (KBR) and IR3535® (3-[N-Butyl-N-acetyl]-aminopropionic acid, ethyl ester).

DEET has been used for insect repellency for over 50 years. Protection is generally provided by direct application to the skin in concentrations ranging from 3 to 100 percent. While results vary across experiments, DEET has been shown to act as an irritant and in some cases may cause skin reactions. In a recent study DEET has also just recently been shown to inhibit acetylcholinesterase in humans, which is an important neurotransmitter. DEET is also known to dissolve several products including certain plastics, synthetic fabrics, painted or varnished surfaces.

Several other terpenoid compounds with repellent properties including thujone, eucalyptol, and linalool have also been identified. Icaridin, which is also called picaridin, is also used as an insect repellent. Similar to DEET, it acts as a repellent to several different insect species. It has also been found to be as effective as DEET at repelling insects, while being less irritating than DEET; however, icaridin is toxic to salamander larvae.

Clearly, traditional vector control methods often involve the heavy use of chemical insecticides that are harmful to the environment and often to human health. Moreover, insects can develop resistance to these chemicals, suggesting that there is a need to identify novel ways of insect control that are effective, cheap, and environmentally friendly. Integrating methods that inhibit vector-human contact, such as vector control and the use of insect repellents, bed nets, or traps, may play a complementary and critical role in controlling the spread of these deadly diseases.

Thus, there is a need for new, improved compositions for compositions that achieve pest control while being safe to use and environmentally friendly.

### BRIEF SUMMARY

The subject invention provides pest control formulations that show enhanced killing efficacy and protection time for an area, or space, to which the formulation is applied. Specifically, in preferred embodiments, the subject invention provides improved compositions that comprise a repellent as well as a pesticide. Advantageously, the compositions and methods of the subject invention are environmentally-friendly, non-toxic, and cost-effective.

In preferred embodiments, the compositions and methods do not harm insects or other organisms that are beneficial for, for example, agriculture and/or horticulture, including pollinating organisms.

In order to reduce the presence of pests in an area of interest, pesticides are typically sprayed upon the materials where they are abundant such as attics, floorboards, plants, plant parts, standing water, produce, harvested plants, leaves, cloths, bed materials, kitchen surfaces, and other surfaces/spaces where pests rest, eat, and/or traverse. Typically, this leads to a certain number of pests dying. However, pests can also stay within crevices, cracks and unreachable places where the pesticide spray cannot reach. The formulations of the subject invention advantageously enhance the efficacy of the pesticide because the repellent causes some of the insects to be agitated and some of the hidden pests to, for example, move out of crevices. Both aspects increase likely contact of the sheltering pest with the pesticidal agent.

In preferred embodiments, pest control compositions are provided that comprise a pesticide formulated with a repellent such as, for example, methyl N,N dimethylanthranilate. In specific embodiments, the pesticide is pyrethrum or permethrin.

The subject invention can also be used for preventing, reducing and/or eliminating infection and/or spread of pest-borne disease through the control of disease vector pests. Even further, the subject invention can be used for reducing pests in the home, drains, backyard, lawn, garden, agricultural crops, and/or agricultural products in storage.

### DETAILED DESCRIPTION OF THE INVENTION

The subject invention provides pest control formulations and their use. Specifically, in preferred embodiments, the subject invention provides improved compositions that comprise a repellent as well as a pesticide. Advantageously, the compositions and methods of the subject invention are environmentally-friendly, non-toxic, and cost-effective. Thus, in preferred embodiments, the compositions and methods do not harm insects or other organisms that are beneficial for, for example, agriculture and/or horticulture, including pollinating organisms.

The subject invention can be used for preventing, reducing and/or eliminating infection and/or spread of pest-borne disease through the control of disease vector pests. Even further, the subject invention can be used for reducing pests in the home, lawn or garden. In further embodiments, the compositions can be used to improve pest control in commercial agriculture operations and the products of such operations.

In certain embodiments, repellent compositions are provided, comprising an arthropod repellent such as, for example, methyl N,N dimethylanthranilate. The arthropod repellant is formulated with a pesticide, thereby creating a pest control composition with very advantageous properties.

In certain embodiments, one or more solvents can be used in the compositions of the subject invention. The solvent can be an oil such as, for example, vegetable oil or derived product including canola oil, peanut oil, olive oil, palm oil, soybean oil, rapeseed oil, cocoa butter, rice bran oil, sunflower oil, coconut oil, corn oil, cottonseed oil, palm oil, safflower oil, Sesamum indicum (sesame) seed oil, or castor bean oil. Solvents can further include water, glycols, and/or alcohols. In certain embodiments, the alcohol can be ethyl alcohol, isopropyl alcohol, 1-propanol, methanol, isobutanol, and/or ethylene glycol. Such ingredients can generally be present in the composition at a concentration of about 10% to about 99.9%, about 20% to about 99.9%, or about 30% to about 99.9%.

Additionally, a vegetable oil-derived product can be used in the compositions of the subject invention. In certain embodiments, the vegetable oil-derived product can be, for example, carboxylic acids, including fatty acids, or combinations of different carboxylic acids thereof. The carboxylic acids can be combined to create copolymers using additives such as, for example, glycerin. Exemplary carboxylic acids include linear saturated dicarboxylic acids, such as, for example, oxalic acid, malonic acid, succinic acid, glutaric acid, adipic acid, pimelic acid, suberic acid, azelaic acid, and sebacic acid. Exemplary fatty acids include saturated fatty acids such as, for example, butryric acid, caproic acid, caprylic acid, capric acid, lauric acid, myristic acid, palmitic acid, stearic acid, arachidic acid, behenic acid, lignoceric acid, cerotic acid, montanic acid, melissic acid, lacceroic acid, geddic acid, hexatriacontylic acid, octatriacontylic acid, or tetracontylic acid; or unsaturated fatty acids, such as for examples, fatty acids with one or more cis or trans configurations. Exemplary unsaturated fatty acids are myristoleic acid, palmitoleic acid, sapienic acid, oleic acid, elaidic acid, vaccenic acid, linoleic acid, linoclaidic acid, arachidonic acid, eicosapentaenoic acid, erucic acid, and docosahexaenoic acid.

In certain embodiments, the repellent composition is formulated for application to clothing, fur, or skin. The composition can also be formulated for application to plants, water, soil, and other surfaces and spaces. In certain embodiments, the composition is formulated as, for example, a liquid, dust, granules, microgranules, pellets, wettable powder, flowable powder, emulsions, microcapsules, oils, lotions, gels, or aerosols.

To improve or stabilize the effects of the composition, it can be blended with suitable adjuvants and then used as such or after dilution if necessary. In preferred embodiments, the composition is formulated as a liquid, which can be mixed with water and other components to form a liquid product.

In one embodiment, the composition comprises an acceptable carrier. The acceptable carrier for purposes of the present invention can be defined as a substance or mixture of substances (e.g., oils, emulsions and suspensions) capable of dispersing the active components without affecting their ability to perform their intended function. The compositions may be in the form of oil, emulsion or suspension type.

### Selected Definitions

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the term “control” used in reference to the activity produced by the subject compositions extends to the act of killing, disabling, immobilizing, or reducing population numbers of a pest, or otherwise rendering the pest substantially incapable of causing harm.

As used herein, a “fragrance” or “fragrance fixative” is a chemical compound that provides the smell of foods, beverages, spices, or other substances. The chemical compound is designed to interact with the olfactory system. The fragrance can be derived from natural sources such as, for example, those derived from plant, animal, or bacterial sources using filtration or enzymatic reactions. Additionally, the fragrance can be derived from synthetic processing of non-eukaryotic or non-bacterial, such as, for example, coal tar and crude oil. The synthetic fragrance often has the exact chemical makeup as the fragrance derived from natural sources, such as, for example ascorbic acid can be purified from oranges or derived from hydrocarbon sources, but the end chemical is C₆H₈O₆ irrespective of the source. Fragrances can also be used as flavoring agents, designed to interact with olfactory and gustatory systems.

As used herein, a “vegetable oil” is oil derived from a plant, combination of plants, seeds of plants, or any other component of plant.

As used herein, the term “arthropod” shall be used in this application; however, it should be understood that the term “arthropod” refers, not only to insects, but also to mites, spiders, ticks, arachnoids, arachnids, larvae, parasites, and like invertebrates.

As used herein, the term “subject” refers to an animal. The animal may be, for example, a human, pig, horse, goat, cat, mouse, rat, dog, ape, fish, chimpanzee, orangutan, guinea pig, hamster, cow, sheep, bird (including chicken), as well as any other vertebrate or invertebrate.

As used herein, “repellent effect” is an effect wherein more arthropods are deterred away from a host or area that has been treated with the composition than a control host or area that has not been treated with the composition. In some embodiments, repellent effect is an effect wherein at least about 50% of arthropods are repelled away from a host or area that has been treated with the composition. In some embodiments, repellent effect is an effect wherein at least about 75% of arthropods are repelled away from a host or area that has been treated with the composition. In some embodiments, repellent effect is an effect wherein at least about 90% of arthropods are repelled away from a host or area that has been treated with the composition. In some embodiments, repellent effect is an effect wherein at least about 95% of arthropods arc repelled away from a host or area that has been treated with the composition. A “repellent” is a chemical composition that provides a repellent effect.

Any compositions or methods provided herein can be combined with one or more of any of the other compositions and methods provided herein.

Other features and advantages of the invention will be apparent from the following description of the preferred embodiments thereof, and from the claims. All references cited herein are hereby incorporated by reference.

### Repellent Ingredients

In preferred embodiments, the subject invention provides pest control compositions that comprise both a repellent and a pesticide, preferably an insecticide. A solvent and/or other ingredients can also be included.

In certain preferred embodiments, the repellent is methyl N,N dimethylanthranilate. Non-limiting examples of other repellants are listed in Table 1A, Table 1B and Table 1C.

TABLE 1A

| Chemical Name | CAS# |
|---|---|
| Hydroxycitronellal methyl anthranilate schiff's base | 89-43-0 |
| beta-napthyl anthranilate | 63449-68-3 |
| linalyl anthranilate | 7149-26-0 |
| Methyl 2-(4-tert-butylphenyl)acetate | 3549-23-3/ |
| | 33155-60-1 |
| 2-isothiocyanatoethylbenzene (Phenethyl Isothiocyanate) | 2257-09-2 |
| Methyl Jasmonate | 39924-52-2 |
| Ethyl anthranilate | 87-25-2 |
| Citrus aurantium flower oil (Neroli extract) | 8016-38-4 |
| Isobutyl Anthranilate | 7779-77-3 |
| Ivy carbaldehyde/methyl anthranilate schiff's base | 68738-99-8 |
| Methyl Anthranilate | 134-20-3 |
| Butyl Anthranilate | 7756-96-9 |
| 4-acetoxy-2,5-dimethyl-3(2h)furanone | 4166-20-5 |
| Isopropyl anthranilate | 18189-02-1 |
| Epsilon-Caprolactam | 105-60-2 |
| 1-(2,6,6-trimethyl-1-cyclohex-2-enyl)hepta-1,6-dien-3- | 79-78-7 |
| one (Allyl Ionone) | |
| acetyl methyl anthranilate | 2719-08-6 |
| methyl dihydrojasmonate | 24851-98-7 |
| 4-methyl cyclohexene | 591-47-9 |
| P-tert-butyl-alpha-methylhydrocinnamal/Methyl | 91-51-0 |
| Anthranilate schiff's base | |
| Phenethyl anthranilate | 133-18-6 |
| 2,4-ivy carbaldehyde/methyl anthranilate schiff's | 68845-02-3 |
| base (triplal) | |

TABLE 1B

| | | | Structural |
|---|---|---|---|
| Name | Structure | Smiles | cluster |
| NR0395222 | 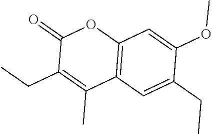 [SMILES: CCc1cc2c(C)c(CC)c(=O)oc2cc1OC] | c12C(═O)[C@@](Cc1cc(c(c2c)COC)C)(CO)C | 1 |
| NR0296309 | 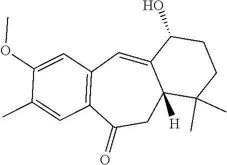 | C12-Cc3c(C(═O)C[C@H]1[C@l(CC[C@H]2O)(C)C)cc(c(c3) OC)C | 1 |
| NR0244708 | 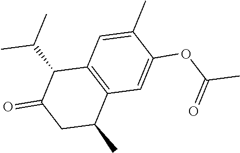 [SMILES: CC(=O)Oc1cc2c(cc1C)[C@@H](C(C)C)C(=O)C[C@@H]2C] | [C@H]1(c2c([C@H](CC1═O)C)cc(c(c2)C)OC(═O)C)[C@@H] (C)C | 1 |
| NR0296386 | 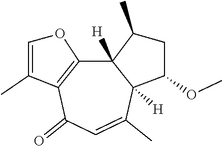 | [C@H]12c3c(C(═O)C═C([C@@H\|1[C@H](C[C@@H]2C)OC) C)c(co3)C | 1 |
| NR0021218 | 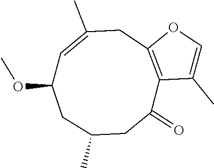 | Cc1coc2c1C(═O)C[c@@H](C[C@H](C═C(C2)C)OC)C | 1 |
| NR0377154 | 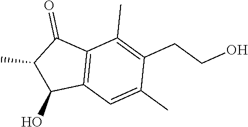 [SMILES: Cc1cc2c(c(C)c1CCO)C(=O)[C@@H](C)[C@@H]2O] | c12c([C@H]([C@@H](C2═O)C)O)cc(c(c1C)CCO)C | 2 |
| NR0325443 | 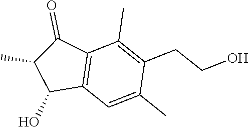 [SMILES: Cc1cc2c(c(C)c1CCO)C(=O)[C@@H](C)[C@H]2O] | c12c([C@@H]([C@@H](C2═O)C)O)cc(c(c1C)CCO)C | 2 |
| NR0045428 | 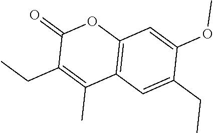 [SMILES: CCc1cc2c(C)c(CC)c(=O)oc2cc1OC] | CCclcc2c(c(c(═O)oc2cc10C)CC)C | 2 |
| NR0296302 | 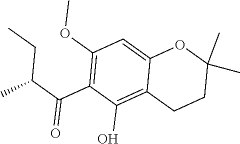 [SMILES: CC[C@@H](C)C(=O)c1c(OC)cc2c(c1O)CCC(C)(C)O2] | c12c(c(c(c(c1)OC)C(═O)[C@@H](CC)C)O)CC[C@](O2)(C)C | 3 |
| NR0381679 | 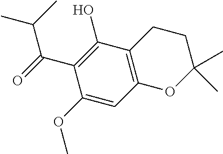 [SMILES: COc1cc2c(c(O)c1C(=O)C(C)C)CCC(C)(C)O2] | c1(c(c2c(cc1OC)O[C@](CC2)(C)C)O)C(═O)[C@@H](C)C | 3 |
| NR0044159 | 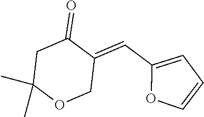 | C[C@@]1(CC(═O)/C(═C/c2ccco2)CO1)C | 4 |

TABLE 1C

| | | | Structural |
|---|---|---|---|
| Name | Structure | Smiles | clusters |
| ZR11 | 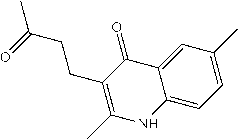 [SMILES: CC(=O)CCc1c(C)[nH]c2ccc(C)cc2c1=O] | CC(═O)CCc1c(C)[nH]c2ccc(C)cc2c1═O | 1 |
| ZR404 | 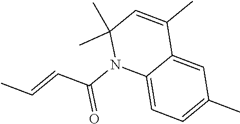 [SMILES: C/C=C/C(=O)N1c2ccc(C)cc2C(C)=CC1(C)C] | C/C═C/C(═O)N1c2ccc(C)cc2C(C)═CC1(C)C | 1 |
| ZR243 | 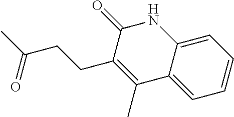 [SMILES: CC(=O)CCc1c(C)c2ccccc2[nH]c1=O] | CC(═O)CCc1c(C)c2ccccc2[nH]c1═O | 1 |
| ZR6 | 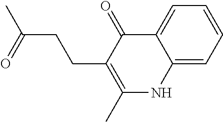 [SMILES: CC(=O)CCc1c(C)[nH]c2ccccc2c1=O] | CC(═O)CCc1c(C)[nH]c2ccccc2c1═O | 1 |
| ZR352 | 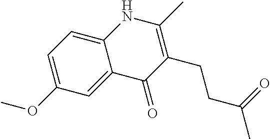 [SMILES: COc1ccc2[nH]c(C)c(CCC(C)=O)c(=O)c2c1] | COc1ccc2[nH]c(C)c(CCC(C)═O)c(═O)c2c1 | 1 |
| ZR135 | 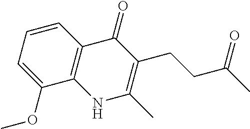 [SMILES: COc1cccc2c(=O)c(CCC(C)=O)c(C)[nH]c12] | COc1cccc2c(═O)c(CCC(C)═O)c(C)[nH]c12 | 1 |
| ZR189 | 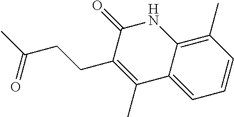 [SMILES: CC(=O)CCc1c(C)c2cccc(C)c2[nH]c1=O] | CC(═O)CCc1c(C)c2cccc(C)c2[nH]c1═O | 1 |
| ZR46 | 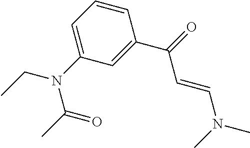 [SMILES: CCN(C(C)=O)c1cccc(C(=O)/C=C/N(C)C)c1] | CCN(C(C)═O)c1cccc(C(═O)/C═C/N(C)C)c1 | 2 |
| ZR52 | 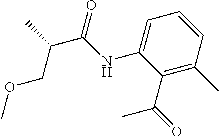 | COC[C@H](C)C(═O)Nc1cccc(C)c1C(C)═O | 2 |
| ZR104 | 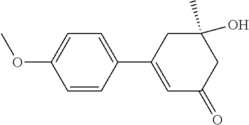 [SMILES: COc1ccc(C2=CC(=O)C[C@](C)(O)C2)cc1] | COc1ccc(C2═CC(═O)c[c@](C)(O)C2)cc1 | 2 |
| ZR268 | 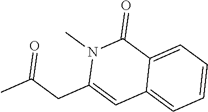 [SMILES: CC(=O)Cc1cc2ccccc2c(=O)n1C] | CC(═O)Cc1cc2ccccc2c(═O)n1C | 2 |
| ZR492 | 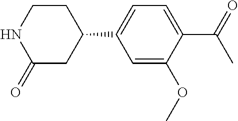 [SMILES: COc1cc([C@H]2CCNC(=O)C2)ccc1C(C)=O] | COc1cc([C@H]2CCNC(═O)C2)ccc1C(C)═O | 2 |
| ZR277 | 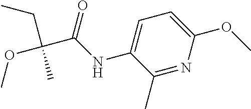 | CC[C@](C)(OC)C(═O)Nc1ccc(OC)nc1C | 2 |
| ZR218 | 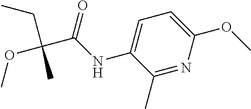 | CC[C@@](C)(OC)C(═O)Nc1ccc(OC)nc1C | 2 |
| ZR403 | 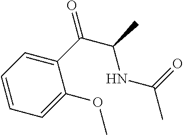 [SMILES: COc1ccccc1C(=O)[C@@H](C)NC(C)=O] | COc1ccccc1C(═O)[C@@H](C)NC(C)═O | 2 |
| ZR389 | 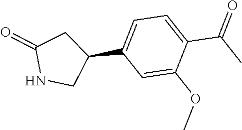 [SMILES: COc1cc([C@H]2CNC(=O)C2)ccc1C(C)=O] | COc1cc([C@H]2CNC(═O)C2)ccc1C(C)═O | 2 |
| ZR388 | 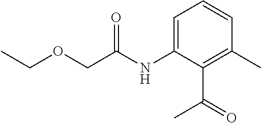 [SMILES: CCOCC(=O)Nc1cccc(C)c1C(C)=O] | CCOCC(═O)Nc1cccc(C)c1C(C)═O | 2 |
| ZR146 | 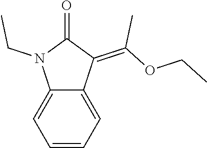 [SMILES: CCO/C(C)=C1/C(=O)N(CC)c2ccccc21] | CCO/C(C)═C1/C(═O)N(CC)c2ccccc21 | 3 |
| ZR234 | 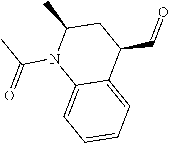 [SMILES: CC(=O)N1c2ccccc2[C@H](C=O)C[C@@H]1C] | CC(═O)N1c2ccccc2[C@H](C═O)C[C@@H]1C | 3 |
| ZR468 | 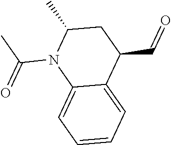 [SMILES: CC(=O)N1c2ccccc2[C@H](C=O)C[C@H]1C] | CC(═O)N1c2ccccc2[C@H](C═O)C[C@H]1C | 3 |
| ZR35 | 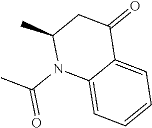 | CC(═O)N1c2ccccc2C(═O)C[C@@H]1C | 3 |

The compositions of the subject invention contain the repellent at a concentration of, for example, about 1% to about 99.9%, about 2% to about 98%, about 3% to about 97%, about 3% to about 96%, or about 3% to about 95%.

In certain embodiments, the concentration of the repellent in a concentrate solution can be about 1% to about 99.9%, about 15% to about 80%, about 20% to about 75%, about 25% to about 70%, about 30% to about 65%, about 35% to about 60%, about 40% to about 55%, or about 50%. In certain embodiments, the concentration of the repellent in a ready-to-use solution can be about 1% to about 99.9%, about 2% to about 98%, about 3% to about 97%, about 3% to about 96%, or about 3% to about 95%.

### Pesticide Ingredients

The pesticidal agent can be, for example, pyrethrum, permethrin or other pesticides. Non-limiting examples of pesticidal agents are listed in Table 2a and Table 2b.

TABLE 2a
Table of compounds with computationally predicted pesticidal activity

| | | | Structural |
|---|---|---|---|
| Structure | Name | Smiles | cluster |
| 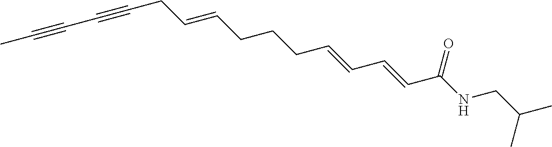 [SMILES: CC#CC#CC/C=C/CCC/C=C/C=C/C(=O)NCC(C)C] | CNP0079038 | CC#CC#CCC═CCCCC═CC═CC(═O)NCC(C)C | 2 |
| 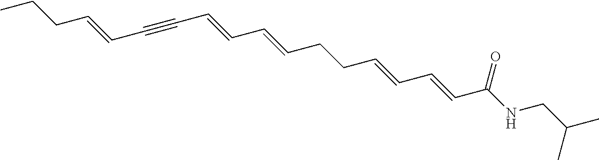 [SMILES: CCC/C=C/C#C/C=C/C=C/CC/C=C/C=C/C(=O)NCC(C)C] | CNP0120904 | CCCC═CC#CC═CC═CCCC═CC═CC(═O)NCC(C)C | 2 |
| 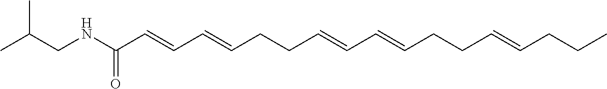 [SMILES: CCC/C=C/CC/C=C/C=C/CC/C=C/C=C/C(=O)NCC(C)C] | CNP0173757 | CCCC═CCCC═CC═CCCC═CC═CC(═O)NCCC(C)C | 2 |
| 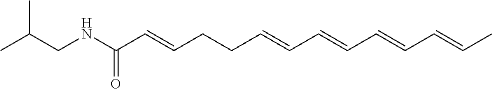 [SMILES: C/C=C/C=C/C=C/C=C/CC/C=C/C(=O)NCC(C)C] | CNP0000298 | CC═CC═CC═CC═CCCC═CC(═O)NCC(C)C | 2 |
| 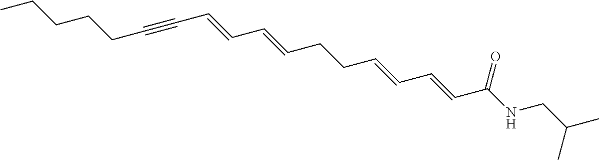 [SMILES: CCCCCC#C/C=C/C=C/CC/C=C/C=C/C(=O)NCC(C)C] | CNP0285570 | CCCCCC#CC═CC═CCCC═CC═CC(═O)NCC(C)C | 2 |
| 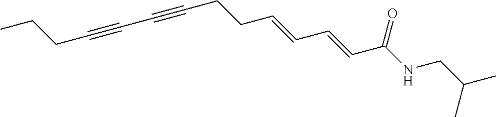 [SMILES: CCCC#CC#CCC/C=C/C=C/C(=O)NCC(C)C] | CNP0412436 | CCCC#CC#CCCC═CC═CC(═O)NCC(C)C | 2 |
| 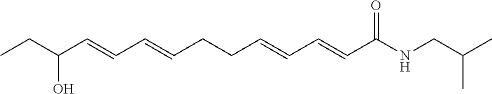 [SMILES: CCC(O)/C=C/C=C/CC/C=C/C=C/C(=O)NCC(C)C] | CNP0106518 | CCC(O)C═CC═CCCC═CC═CC(═O)NCC(C)C | 2 |
| 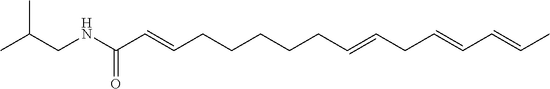 [SMILES: C/C=C/C=C/C/C=C/CCCCC/C=C/C(=O)NCC(C)C] | CNP0180805 | CC═CC═CCC═CCCCCCC═CC(═O)NCC(C)C | 2 |
| 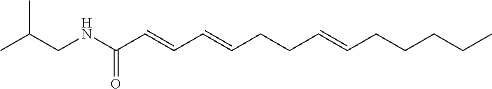 [SMILES: CCCCC/C=C/CC/C=C/C=C/C(=O)NCC(C)C] | CNP0382644 | CCCCCCC═CCCC═CC═CC(═O)NCC(C)C | 2 |
| 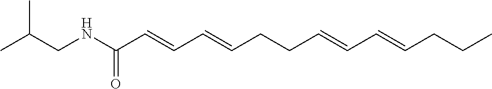 [SMILES: CCC/C=C/C=C/CC/C=C/C=C/C(=O)NCC(C)C] | CNP0108086 | CCCC═CC═CCCC═CC═CC(═)NCC(C)C | 2 |
| 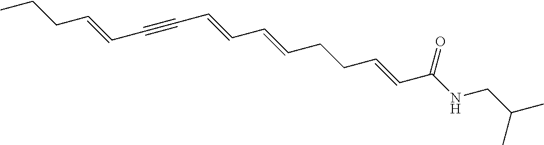 [SMILES: CCC/C=C/C#C/C=C/C=C/CC/C=C/C(=O)NCC(C)C] | CNP0202290 | CCCC═CC#CC═CC═CCCC═CC(═O)NCC(C)C | 2 |
| 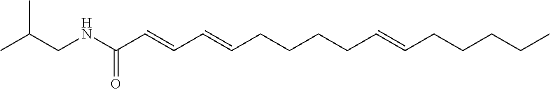 [SMILES: CCCCC/C=C/CCCC/C=C/C=C/C(=O)NCC(C)C] | CNP0203398 | CCCCCC═CCCCCCC═CC═CC(C═O)NCC(C)C | 2 |
| 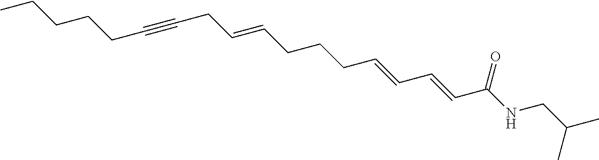 [SMILES: CCCCCC#CC/C=C/CCC/C=C/C=C/C(=O)NCC(C)C] | CNP0273658 | CCCCCC#CCC═CCCCC═CC═CC(═O)NCC(C)C | 2 |
| 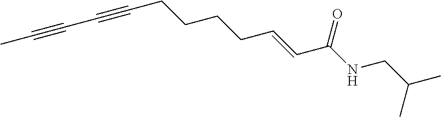 [SMILES: CC#CC#CCCCC/C=C/C(=O)NCC(C)C] | CNP0342741 | CC#CC#CCCCCC═CC(═O)NCC(C)C | 2 |
| 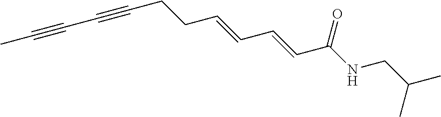 [SMILES: CC#CC#CCC/C=C/C=C/C(=O)NCC(C)C] | CNP0183160 | CC#CC#CCCC═CC═CC(═O)NCC(C)C | 2 |
| 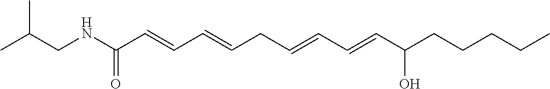 [SMILES: CCCCCC(O)/C=C/C=C/C/C=C/C=C/C(=O)NCC(C)C] | CNP0069800 | CCCCCC(O)C═CC═CCC═CC═CC(═O)NCC(C)C | 2 |
| 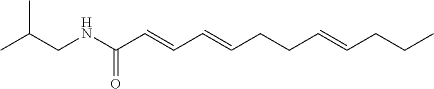 [SMILES: CCC/C=C/CC/C=C/C=C/C(=O)NCC(C)C] | CNP0258229 | CCCC═CCCC═CC═CC(═O)NCC(C)C | 2 |
| 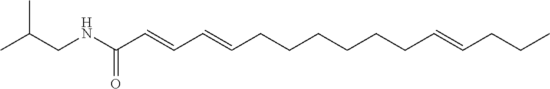 [SMILES: CCC/C=C/CCCCCC/C=C/C=C/C(=O)NCC(C)C] | CNP0400629 | CCCC═CCCCCCCC═CC═CC(═O)NCC(C)C | 2 |
| 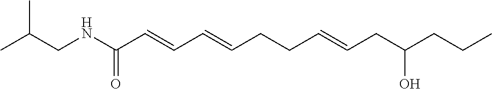 [SMILES: CCCC(O)C/C=C/CC/C=C/C=C/C(=O)NCC(C)C] | CNP0318069 | CCCC(O)CC═CCCC═CC═CC(═O)NCC(C)C | 2 |
| 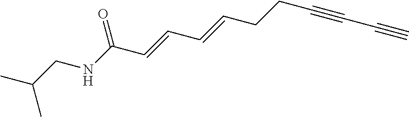 [SMILES: C#CC#CCC/C=C/C=C/C(=O)NCC(C)C] | CNP0264889 | C#CC#CCCC═CC═CC(═O)NCC(C)C | 2 |
| 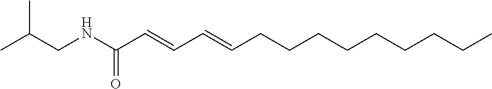 [SMILES: CCCCCCCCC/C=C/C=C/C(=O)NCC(C)C] | CNP0131538 | CCCCCCCCCC═CC═CC(═O)NCC(C)C | 2 |
| 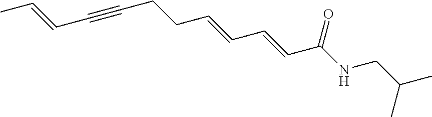 [SMILES: C/C=C/C#CCC/C=C/C=C/C(=O)NCC(C)C] | CNP0176409 | CC═CC#CCCC═CC═CC(═O)NCC(C)C | 2 |
| 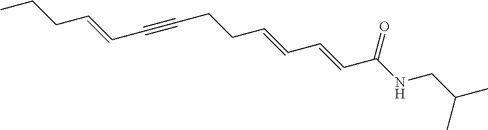 [SMILES: CCC/C=C/C#CCC/C=C/C=C/C(=O)NCC(C)C] | CNP0148322 | CCCC═CC#CCCC═CC═CC(═O)NCC(C)C | 2 |
| 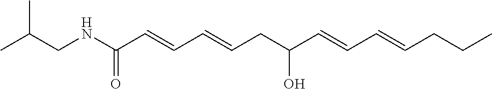 [SMILES: CCC/C=C/C=C/C(O)C/C=C/C=C/C(=O)NCC(C)C] | CNP0144547 | CCCC═CC═CC(O)CC═CC═CC(═O)NCC(C)C | 2 |
| 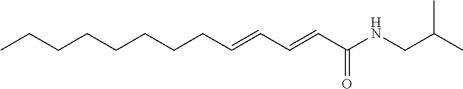 [SMILES: CCCCCCCC/C=C/C=C/C(=O)NCC(C)C] | CNP0317580 | CCCCCCCCC═CC═CC(═O)NCC(C)C | 2 |
| 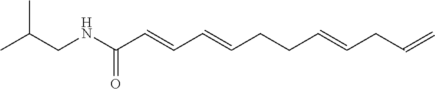 [SMILES: C=CC/C=C/CC/C=C/C=C/C(=O)NCC(C)C] | CNP0217844 | C═CCC═CCCC═CC═CC(═O)NCC(C)C | 2 |
| 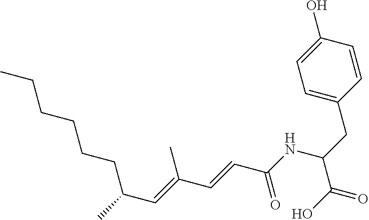 [SMILES: CCCCCC[C@@H](C)/C=C(C)/C=C/C(=O)NC(Cc1ccc(O)cc1)C(=O)O] | NPA012598 | CCCCCC[C@@H](C)/C═C(\C)/C═C/ C(═O)NC(CC1═CC═C(C═C1)O)C(═O)O | 3 |
| 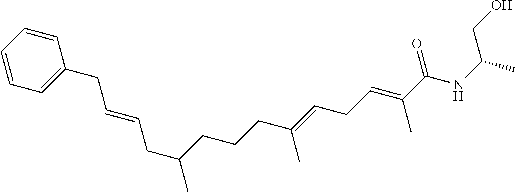 [SMILES: C/C(=C\C/C=C(\C)C(=O)N[C@@H](C)CO)CCCC(C)C/C=C/Cc1ccccc1] | NPA009464 | C[C@@H](CO)NC(═O)/C(═C/C/C═C(\C)/CCCC(C)C/C═C/ CC1═CC═CC═C1)/C | 3 |
| 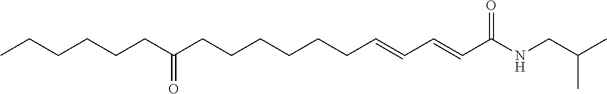 [SMILES: CCCCCCC(=O)CCCCCC/C=C/C=C/C(=O)NCC(C)C] | CNP0210890 | CCCCCCC(═O)CCCCCCC═CC═CC(═O)NCC(C)C | 2 |
| 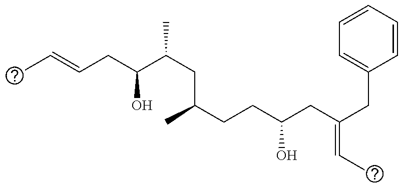 [SMILES: C/C=C/C[C@H](O)[C@H](C)C[C@H](C)CC[C@@H](O)C/C(=C/C)Cc1ccccc1] | NPA027277 | C[C@H](CC[C@@H](O)C/C(═C/Cl(CC1═CC═CC═C1)C[C@@H](C) [C@@H](O)C/C═C/Cl | 3 |
| 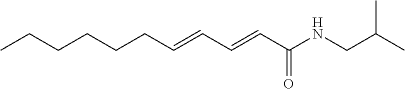 [SMILES: CCCCCC/C=C/C=C/C(=O)NCC(C)C] | CNP0350652 | CCCCCCC═CC═CC(═O)NCC(C)C | 2 |
| 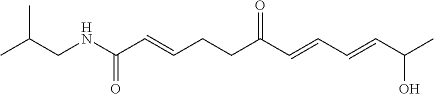 [SMILES: CC(O)/C=C/C=C/C(=O)CC/C=C/C(=O)NCC(C)C] | CNP0186174 | CC(O)C═CC═CC(═O)CCC═CC(═O))NCC(C)C | 2 |
| 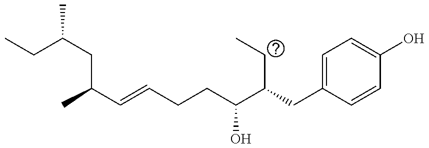 [SMILES: CC[C@H](C)C[C@H](C)/C=C/CC[C@@H](O)[C@H](CC)Cc1ccc(O)cc1] | NPA010389 | CC[C@H](C)C[C@H](C)/C═C/CC[C@@H](O)[C@@H] (CC1═CC═C(O)C═C1)NC | 3 |
| 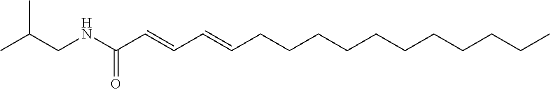 [SMILES: CCCCCCCCCCC/C=C/C=C/C(=O)NCC(C)C] | CNP0363255 | CCCCCCCCCCCC═CC═CC(═O)NCC(C)C | 2 |
| 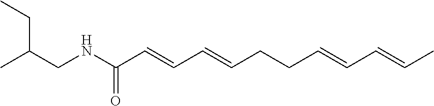 [SMILES: C/C=C/C=C/CC/C=C/C=C/C(=O)NCC(C)CC] | CNP0151615 | CC═CC═CCCC═CC═CC(═O)NCC(C)CC | 2 |
| 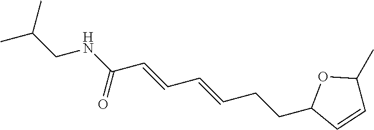 [SMILES: CC(C)CNC(=O)/C=C/C=C/CCC1C=CC(C)O1] | CNP0105906 | CC(C)CNC(═O)C═CC═CCCC1C═CC(C)O1 | 2 |
| 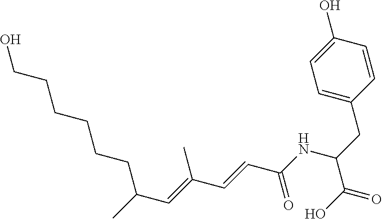 [SMILES: CC(/C=C/C(=O)NC(Cc1ccc(O)cc1)C(=O)O)=C\C(C)CCCCCCO] | NPA018066 | CC(CCCCCCO)/C═C(\C)/C═C/C(═O)NC(CC1═CC═C(C═C1O)C(═O)O | 3 |
| 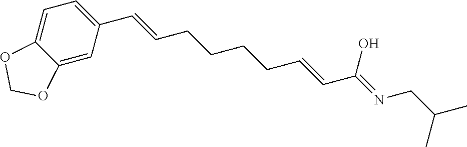 [SMILES: CC(C)C/N=C(O)/C=C/CCCC/C=C/c1ccc2c(c1)OCO2] | CNP0275302 | CC(C)CN═C(O)C═CCCCCC═Cc1ccc2c(C1)OCO2 | 3 |
| 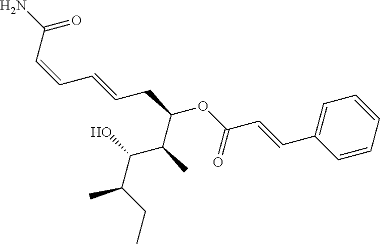 [SMILES: CC[C@@H](C)[C@H](O)[C@H](C)[C@@H](C/C=C/C=C\C(N)=O)OC(=O)/C=C/c1ccccc1] | NPA018193 | CC[C@@H](C)[C@@H][(C@H](C)[C@@H](C/C═C/C═C\C(═O)N) OC(═O)/C═C/C1═CC═CC═C1)O | 3 |
| 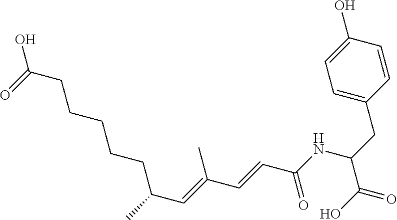 [SMILES: CC(/C=C/C(=O)NC(Cc1ccc(O)cc1)C(=O)O)=C\[C@H](C)CCCCCC(=O)O] | NPA007801 | C[C@H](CCCCCC(═O)O)/C═C(\C)/C═C/C(═O)NC(CC1═CC═C(C═C1)O)C(═O)O | 3 |
| 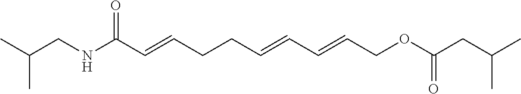 [SMILES: CC(C)CNC(=O)/C=C/CC/C=C/C=C/COC(=O)CC(C)C] | CNP0102711 | CC(C)CNC(═O)C═CCCC═CC═CCOC(═O)CC(C)C | 2 |
| 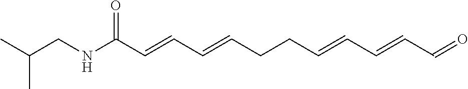 [SMILES: CC(C)CNC(=O)/C=C/C=C/CC/C=C/C=C/C=O] | CNP0309377 | CC(C)CNC(═O)C═CC═CCCC═CC═CC═O | 2 |
| 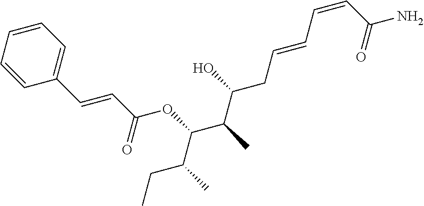 [SMILES: CC[C@@H](C)[C@H](OC(=O)/C=C/c1ccccc1)[C@H](C)[C@H](O)C/C=C/C=C\C(N)=O] | NPA007306 | CC[C@@H](C)[C@@H]([C@H](C)[C@@H](C/C═C/ C═C\C(═O)N)O)OC(═O)/C═C/C1═CC═CC═C1 | 3 |
| 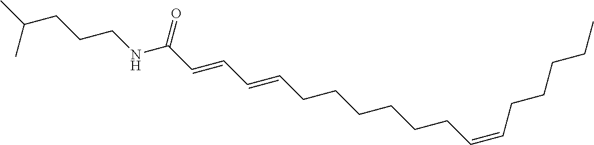 [SMILES: CCCCC/C=C\CCCCCC/C=C/C=C/C(=O)NCCCC(C)C] | ZINC95914430 | CCCC/C═C\CCCCCC/C═C/C═C/C(═O)NCCCC(C)C | 2 |
| 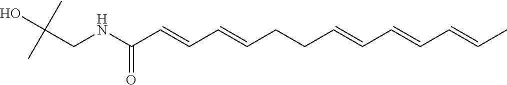 [SMILES: C/C=C/C=C/C=C/CC/C=C/C=C/C(=O)NCC(C)(C)O] | CNP0215473 | CC═CC═CC═CCCC═CC═CC(═O)NCC(C)(C)O | 2 |
| 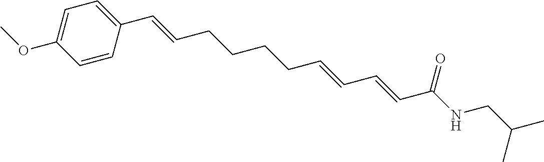 [SMILES: COc1ccc(/C=C/CCCC/C=C/C=C/C(=O)NCC(C)C)cc1] | CNP0257645 | COc1ccc(C═CCCCCC═CC═CC(═O)NCC(C)C)cc1 | 3 |
| 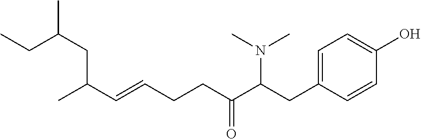 [SMILES: CCC(C)CC(C)/C=C/CCC(=O)C(Cc1ccc(O)cc1)N(C)C] | NPA017706 | CCC(C)CC(C)/C═C/CCC(═O)C(CC1═CC═C(C═C1)O)N(C)C | 3 |
| 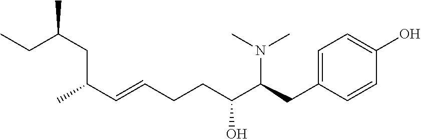 [SMILES: CC[C@@H](C)C[C@@H](C)/C=C/CC[C@@H](O)[C@H](Cc1ccc(O)cc1)N(C)C] | NPA018423 | CC[C@@H](C)C[C@@H](C)C═CCC[C@H]([C@H] CC1═CC═C(C═C1)O)N(C)C)O | 3 |
| 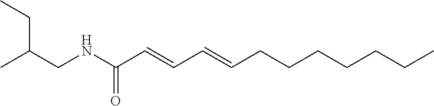 [SMILES: CCCCCCC/C=C/C=C/C(=O)NCC(C)CC] | CNP0132760 | CCCCCCCC═CC═CC(═O)NCC(C)CC | 2 |
| 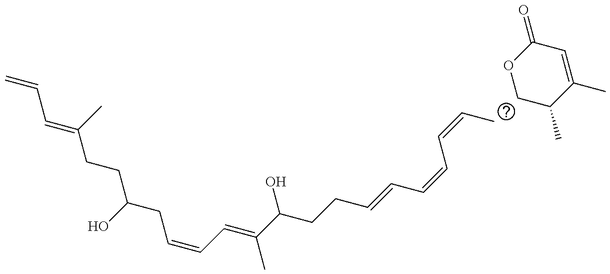 | NPA014867 | C[C@@H ]1[C@@H](OC(═O)C═C1C)C/C═C\C═C/C═C/CCC(/C(═C/ C═C\CC(CC/C(═C/C═C)/C)O)/C)O | 3 |
| 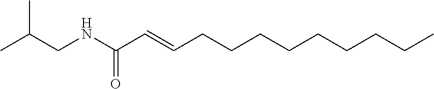 [SMILES: CCCCCCCCC/C=C/C(=O)NCC(C)C] | CNP0001094 | CCCCCCCCCC═CC(═O)NCC(C)C | 2 |
| 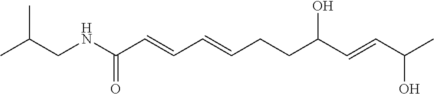 [SMILES: CC(O)/C=C/C(O)CC/C=C/C=C/C(=O)NCC(C)C] | CNP0366513 | CC(O)C═CC(O)CCC═CC═CC(═O)NCC(C)C | 2 |
| 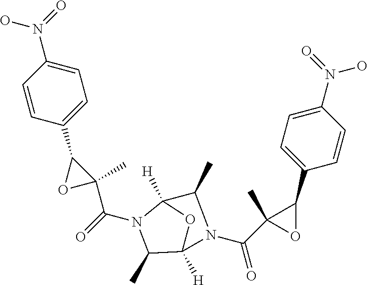 | NPA004794 | C[C@@H]1[C@@H]2N([C@@H]([C=@H](N1C(═O)[C@@]3([C@H](O3) C4═CC═C(C═C4)[N+](═O)[O—])C)O2)C)C(═O[C@@]5([C@H](O5) C6═CC═C(C═C6)(N+)(═O)[O—])C | 1 |
| 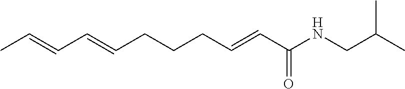 [SMILES: C/C=C/C=C/CCC/C=C/C(=O)NCC(C)C] | CNP0149729 | CC═CC═CCCCC═CC(═O)NCC(C)C | 2 |
| 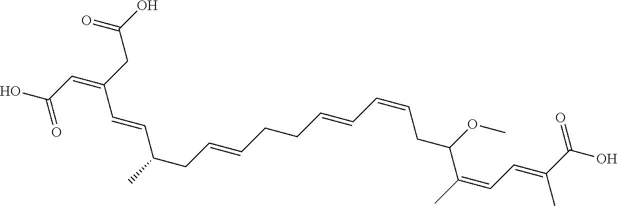 [SMILES: COC(C/C=C\C=C\CC/C=C/C[C@H](C)/C=C/C(=C\C(=O)O)CC(=O)O)/C(C)=C\C=C(/C)C(=O)O] | NPA017560 | C[C@@H](C/C═C/CC/C═C/C═C\C[C@H](/C(═C\C═C(/C)\C(═O)O)/ C)OC)/C═C/C(═C\C(═O)O)/CC(═O)O | 3 |
| 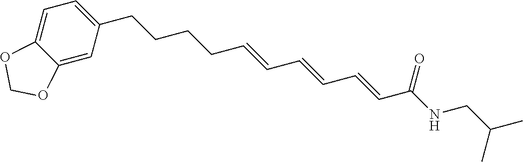 [SMILES: CC(C)CNC(=O)/C=C/C=C/C=C/CCCCc1ccc2c(c1)OCO2] | Amb24325948 | CC(C)CNC(═)/C═C/C═C/C═C/CCCCc1ccc2c(c1)OCO2 | 3 |
| 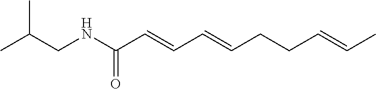 [SMILES: C/C=C/CC/C=C/C=C/C(=O)NCC(C)C] | CNP0401507 | CC═CCCC═CC═CC(═O)NCC(CO)C | 2 |
| 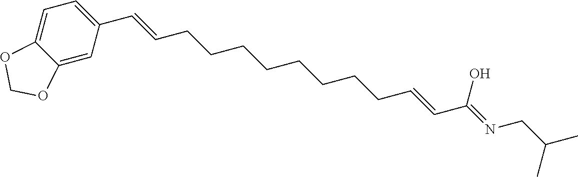 [SMILES: CC(C)C/N=C(O)/C=C/CCCCCCCC/C=C/c1ccc2c(c1)OCO2] | CNP0210755 | CC(C)CN═C(O)C═CCCCCCCCCC═Cc1ccc2c(c1)OCO2 | 3 |
| 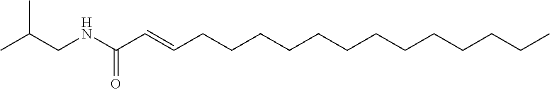 [SMILES: CCCCCCCCCCCCC/C=C/C(=O)NCC(C)C] | CNP0120027 | CCCCCCCCCCCCCC═CC(═O)NCC(C)C | 2 |
| 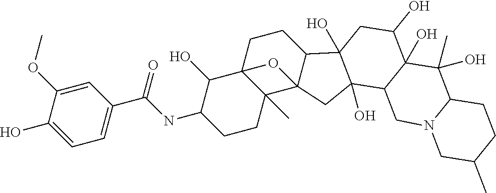 [SMILES: COc1cc(C(=O)NC2CCC3(C)C4(CCC5C6(O)CC(O)C7(O)C(CN8CC(C)CCC8C7(C)O)C6(O)CC53O4)C2O)ccc1O] | CNP0172046 | COc1cc(C(═O)OC2CCC3(C)C4CCC5C6(O)CC(O)C7(O)(CN8CC(C) CCC8C7(C)O)C6(O)CC53Oc24O)ccc1O | 1 |
| 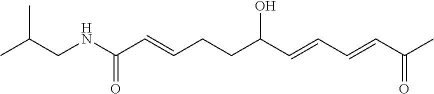 [SMILES: CC(=O)/C=C/C=C/C(O)CC/C=C/C(=O)NCC(C)C] | CNP0000307 | CC(═O)C═CC═CC(O)CCC═CC(═O)NCC(C)C | 2 |
| 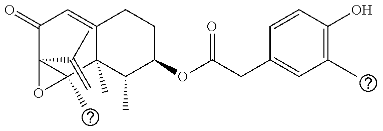 | NPA019908 | C[C@H]1[C@@H](CCC2═CC(═O)[C@]3([C@@H]([C@] 12C)O3)C(═C)C)OC(═O)CC4═CC(═C(C═C4)O)Cl | 3 |
| 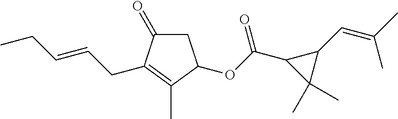 [SMILES: CC/C=C/CC1=C(C)C(OC(=O)C2C(C=C(C)C)C2(C)C)CC1=O] | CNP0164761 | CCC═CCC1═C(C)C(OC(═O)C2C(C═C(C)C)C2(C)C)CC1═O | 3 |
| 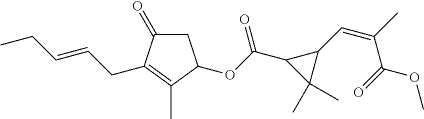 [SMILES: CC/C=C/CC1=C(C)C(OC(=O)C2C(/C=C(/C)C(=O)OC)C2(C)C)CC1=O] | CNP0392167 | CCC═CCC1═C(C)C(OC(═O)C2C(C═C(C)C(═O)OC)C2(C)C)CC1═O | 3 |
| 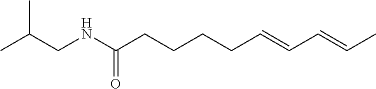 [SMILES: C/C=C/C=C/CCCCC(=O)NCC(C)C] | CNP0176238 | CC═CC═CCCCCC(═O)NCC(C)C | 2 |
| 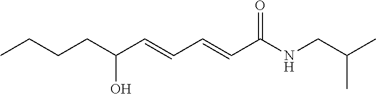 [SMILES: CCCCC(O)/C=C/C=C/C(=O)NCC(C)C] | CNP0191380 | CCCCC(O)C═CC═CC(═O)NCC(C)C | 2 |
| 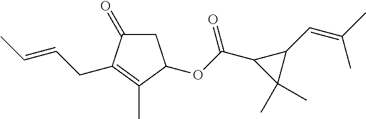 [SMILES: C/C=C/CC1=C(C)C(OC(=O)C2C(C=C(C)C)C2(C)C)CC1=O] | CNP0252689 | CC═CCC1═C(C)C(OC(═O)C2C(C═C(C)C)C2(C)C)CC1═O | 3 |
| 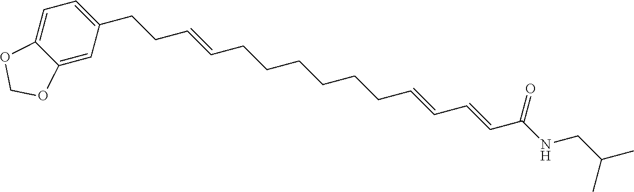 [SMILES: CC(C)CNC(=O)/C=C/C=C/CCCCCC/C=C/CCc1ccc2c(c1)OCO2] | CNP0377554 | CC(C)CNC(═O)C═CC═CCCCCCCC═CCCc1ccc2c(c1)OCO2 | 3 |
| 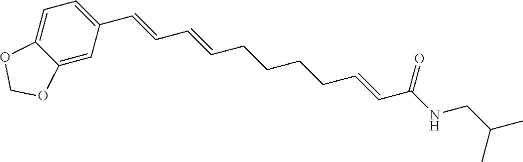 [SMILES: CC(C)CNC(=O)/C=C/CCCC/C=C/C=C/c1ccc2c(c1)OCO2] | CNP0251537 | CC(C)CNC(═O)C═CCCCCC═CC═Cc1ccc2c(c1)OCO2 | 3 |
| 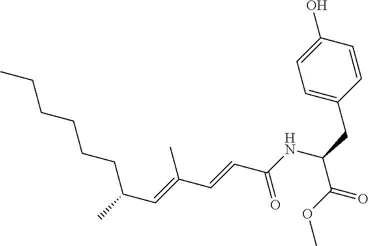 [SMILES: CCCCCC[C@@H](C)/C=C(C)/C=C/C(=O)N[C@@H](Cc1ccc(O)cc1)C(=O)OC] | NPA008658 | CCCCCC[C@@H](C)/C═C(\C)/C═C/ C(═O)N[C@@H](CC1═CC═C(C═C1)O)C(═O)OC | 3 |
| 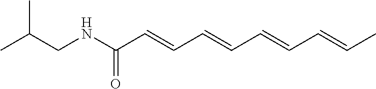 [SMILES: C/C=C/C=C/C=C/C=C/C(=O)NCC(C)C] | CNP0000309 | CC═CC═CC═CC═CC(═O)NCC(C)C | 2 |
| 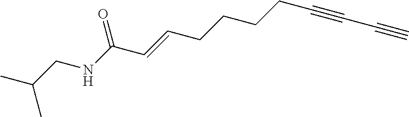 [SMILES: C#CC#CCCCC/C=C/C(=O)NCC(C)C] | CNP01580381 | C#CC#CCCCCC═CC(═O)NCC(C)C | 2 |
| 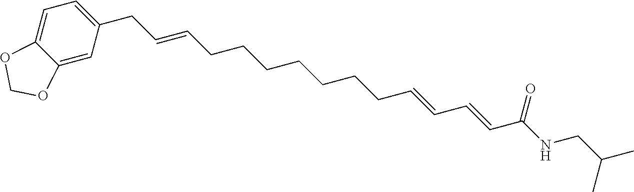 [SMILES: CC(C)CNC(=O)/C=C/C=C/CCCCCCC/C=C/Cc1ccc2c(c1)OCO2] | ZINC13378981 | CC(C)CNC(═O)/C═C/C═C/CCCCCCC/C═C/Cc1ccc2c(c1)OCO2 | 3 |
| 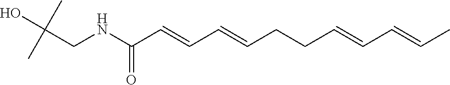 [SMILES: C/C=C/C=C/CC/C=C/C=C/C(=O)NCC(C)(C)O] | CNP0193270 | CC═CC═CCCC═CC═CC(═O)NCC(C)(C)O | 2 |
| 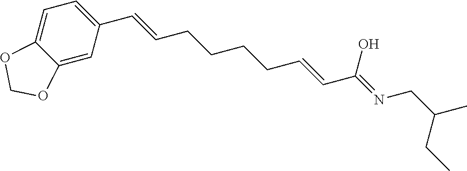 [SMILES: CCC(C)C/N=C(O)/C=C/CCCC/C=C/c1ccc2c(c1)OCO2] | CNP0120219 | CCC(C)CN═C(O)C═CCCCCC═Cc1ccc2c(c1)OCO2 | 3 |

TABLE 2b
Name

pyrethrum
Sodium Lauryl Sulfate
Rosemary Oil
Peppermint Oil
Thyme Oil
Cinnamon OIl
Garlic Oil
Clove Oil
Cedar Wood Oil
1% Spearmint Oil
Neem Oil
Sumithrin
d-Phenothrin
Prallethrin
Deltamethrin
Fipronil
Hydramethylnon
Hydroprene
Methoprene
pyriproxyfen
Diatomaceous Earth
d-Phenothrin, N-Octyl Bicyclopheptene Dicarboximide
Imidacloprid, 1% n-Octyl bicycloheptene dicarboximide
d-Phenothrin
Clothianidin
Metofluthrin
(S)-methoprene
Pyriproxyfen
Flumethrin
Selamectin
Dinotefuran
Spinetoram
Fluralenar
Indozacarb
coumaphos
piperonyl butoxide
cyfluthrin
Acramite (bifenazate)
Aldicarb
Asana XL (esfenvalerate)
Bacillus thuringiensis (bacterium)
Baythroid (cyfluthrin)
Beta-cyfluthrin (pyrethyroid)
Carbaryl (carbamate)
carbofuran
Chlorpyrifos (organophosphate)
Cruiser 5FS (thiamethoxam)
Cygon 400 (dimethoate)
Cythion 57% (malathion)
Diazinon (organophosphate)
Dibrom 8E
Dimethoate (organophosphate)
Dimilin (diflubenzuron)
Dipel 2X
Endosulfan (organochlorine)
Esfenvalerate (pyrethroid)
Fulfill (pymetrozine)
Gama- and Lamda-cyhalothrin (pyrethroid)
Guthion (azinphos methyl)
Idoxacard (carboxylate)
Imidan (phosmet)
Kelthane (dicofol)
Lanate (methomyl)
Malathion (organophosphate)
Metasystox-R
Methidathion (organophosphate)
Methomyl (carbamate)
Methoxychlor (methoxychlor)
Methyl parathion (organophosphate)
MSR (oxydemeton-methyl)
Mustang Max (pyrethroid)
Neemix
Nufos 4E (chlorpyrifos)
Parathion 4E
Permethrin
Phosmet (organophosphate)
Provado (imidacloprid)
Pyrethrins
Sevin (carbaryl)
Telfluthrin
Temik (aldicarb
terbufos
Thiodan (endosulfan)
Vendex (hexakis fenbutatin-oxide)
Warrior (organophosphate)
Zeal (etoxazole)
Zolone 3EC
Zeta-Cypermethrin
Sulfur
Spinosad (spinosyn A and spinosad D)
Potassium Salts of Fatty Acids
Bifenthrin
cypermethrin
tebuconazole
tau-fluvalinate
carabryl
insectidal soap

Such pesticidal ingredients can generally be present in the formulation at a concentration of, for example, about 0.001% to about 5%, about 0.05% to about 15%, or about 0.1% to about 10%.

In certain embodiments, the concentration of the pesticidal agent in a concentrate solution can be about 10% to about 99.9%, about 15% to about 80%, about 20% to about 75%, about 25% to about 70%, about 30% to about 65%, about 35% to about 60%, about 40% to about 55%, or about 50%. In certain embodiments, the concentration of the pesticidal agent in a ready-to-use solution can be about 0.001% to about 5%, about 0.05% to about 15%, or about 0.1% to about 10%.

### Antimicrobial and Antifungal Agents

The compositions of the present invention may contain an antimicrobial or antifungal agent. Such agents are capable of destroying microbes, preventing the development of microbes or preventing the pathogenic action of microbes. A safe and effective amount of an antimicrobial or antifungal agent may be added to the present compositions, preferably, from about 0.001% to about 10%, more preferably from about 0.01% to about 5%, and still more preferably from about 0.05% to about 2%.

Additionally antimicrobial peptides can be used.

### Composition Preparation

The compositions useful for the methods of the present invention are generally prepared by conventional methods such as are known in the art of making such compositions. Such methods typically involve mixing of the ingredients in one or more steps to a relatively uniform state, with or without heating, cooling, application of vacuum, and the like.

### Preservatives

Preservatives can be incorporated into the compositions of the present invention to protect against the growth of potentially harmful microorganisms. While it is in the aqueous phase that microorganisms tend to grow, microorganisms can also reside in the anhydrous or oil phase. As such, preservatives, which have solubility in both water and oil, are preferably employed in the present compositions. Suitable traditional preservatives for compositions of this invention are alkyl esters of parahydroxybenzoic acid. Other preservatives, which can be used include hydantoin derivatives, propionate salts, and a variety of quaternary ammonium compounds.

Particularly preferred preservatives are methylparaben, imidazolidinyl urea, sodium dehydroacetate, propylparaben, trisodium ethylenediamine tetraacetate (EDTA), and benzyl alcohol. The preservative can be selected to avoid possible incompatibilities between the preservative and other ingredients. Preservatives are preferably employed in amounts ranging from about 0.01% to about 2% by weight of the composition. Other preservatives known in the art can be used in the present invention.

### Agricultural Use

In certain embodiments, the subject invention provides methods of improving plant health and/or increasing crop yield by applying the composition disclosed herein to, for example, pests, soil, seed, and plant parts. Advantageously, the method can effectively control pests, and the corresponding diseases caused by pests while a yield increase is achieved and side effects and additional costs are avoided.

In one embodiment, the composition can be applied to an already germinated and/or growing plant including roots, stems, and leaves. The composition may also be applied as a seed treatment. The use as a seed treatment is beneficial because the application can be achieved easily, and the amount used for treatment may be reduced, further reducing the potential toxicity, if any.

In one embodiment, the pest control composition may be added to the soil, plants' growing medium, plants, aquatic medium, or any area to be treated to prevent pest damage.

In certain embodiments, the composition may be applied by spraying, pouring, dipping, in the form of concentrated or diluted liquids, solutions, suspensions, powders, and the like, containing such concentrations of the active agent as is most suited for a particular purpose at hand.

In one embodiment, the composition according to the subject invention may be applied at about 0.0001 pounds/acre to about 10 pounds/acre, about 0.001 pounds/acre to about 5 pounds/acre, about 0.01 pounds/acre to about 1 pounds/acre, about 0.01 pounds/acre to about 0.1 pounds/acre, or about 0.01 pounds/acre to about 0.05 pounds/acre.

In one embodiment, the composition according to the subject invention is applied to the plant or crop from about 1 to about 100 days, about 2 to about 50 days, about 10 to about 40 days, about 20 to about 30 days after the initial application to soil or seed.

In specific embodiments, the compositions may be, for example, introduced into an irrigation system, sprayed from a backpack or similar devices, applied by a land based or airborne robotic device such as a drone, and/or applied with a seed.

Seed application may be by, for example, a seed coating or by applying the composition to the soil contemporaneously with the planting of seeds. This may be automated by, for example, providing a device or an irrigation system that applies the microbe-based composition along with, and/or adjacent to, seeds at, or near, the time of planting the seeds. Thus, the composition can be applied within, for example, 5, 4, 3, 2, or 1 day before or after the time of plantings or simultaneously with planting of the seeds.

Reference herein to administration of the composition “on or near” a pest or a plant, or to the “environment” of a pest or plant, means that the administration is such that the composition is sufficiently in contact with the pest or plant such that the desired result (e.g., killing or repelling the pest, increasing yield, preventing damage to the plant, etc.) is achieved. This may typically be within, for example, 10, 5, 3, 2, or 1 feet or less, of the pest, plant, weed, or other desired target.

### Target Plants

Plants that can benefit from application of the products and methods of the subject invention include: Row Crops (e.g., Corn, Soy, Sorghum, Peanuts, Potatoes, etc.), Field Crops (e.g., Alfalfa, Wheat, Grains, etc.), Tree Crops (e.g., Walnuts, Almonds, Pecans, Hazelnuts, Pistachios, etc.), Citrus Crops (e.g., orange, lemon, grapefruit, etc.), Fruit Crops (e.g., apples, pears, etc.), Turf Crops, Ornamentals Crops (e.g., Flowers, vines, etc.), Vegetables (e.g., tomatoes, carrots, etc.), Vine Crops (e.g., Grapes, Strawberries, Blueberries, Blackberries, etc.), Forestry (e.g., pine, spruce, eucalyptus, poplar, etc.), Managed Pastures (any mix of plants used to support grazing animals).

The benefit can be in the form of, for example, increased yield, quality, and disease and pest reduction.

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., Avena sativa, Avena fatua, Avena byzantina, Avena fatua var. sativa, Avena hybrida), Averrhoa carambola, Bambusa sp., Benincasa hispida, Bertholletia excelsea, Beta vulgaris, Brassica spp. (e.g., Brassica napus, Brassica rapa ssp. [canola, oilseed rape, turnip rape]), Cadaba farinosa, Camellia sinensis, Canna indica, Cannabis sativa, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., Elacis guineensis, Elaeis oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., Glycine max, Soja hispida or Soja max), Gossypium hirsutum, Helianthus spp. (e.g., Helianthus annuus), Hemerocallis fulva, Hibiscus spp., Hordeum spp. (e.g., Hordeum vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., Lycopersicon esculentum, Lycopersicon lycopersicum, Lycopersicon pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., Oryza sativa, Oryza latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., Solanum tuberosum, Solanum integrifolium or Solanum lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., Triticum aestivum, Triticum durum, Triticum turgidum, Triticum hybernum, Triticum macha, Triticum sativum, Triticum monococcum or Triticum vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisctum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoca batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Further plants of interest include Cannabis (e.g., sativa, indica, and ruderalis) and industrial hemp.

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

All plants and plant parts can be treated in accordance with the invention. In this context, plants are understood as meaning all plants and plant populations, such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

### Target Pests

The compositions and methods of the subject invention can be used to reduce damage caused by a wide range of pests.

Examples of the classification of pests include Lepidoptera (for example, Plutellidae, Noctuidac, Pyralidae, Tortricidae, Lyonctiidae, Carposinidae, Gelechiidae, Crambidae, Arctiidae, and Lymantriidae), Hemiptera (for example, Cicadellidae, Delphacidae, Psyllidae, Aphididae, Aleyrodidac, Orthezidae, Miridae, Tingidae, Pentatomidac, and Lygaiedac), Coleoptera (for example, Scarabaeidae, Flateridae, Coccinellidae, Cerambycidae, Chrysomelidae, and Curculionidae), Diptera (for example, Muscidae, Calliphoridae, Sarcophagidac, Anthomyiidae, Tephritidae, Opomyzoidea, and Carnoidea), Orthoptera (for example, Acrididac, Catantopidae, and Pyrgomorphidae), Thysanoptera (for example, Thripidae, Aeolothripidae, and Merothripidae), Tylenchida (for example, Aphelenchoididac and Ncotylechidae), Collembola (for example, Onychiurus and Isotomidae), Acarina (for example, Tetranychidae, Dermanyssidae, Acaridac, and Sarcoptidae), Stylommatophora (for example, Philomycidac and Bradybaenidae), Ascaridida (for example, Ascaridida and Anisakidae), Opisthorchiida, Strigeidida, Blattodea (for example, Blaberidac, Cryptocercidae, and Panesthiidae) and Thysanura (for example, Lepismatidae, Lepidotrichidae, and Nicoletiidae).

Examples of the pests belonging to Lepidoptera include Chilo suppressalis Walker, Cnaphalocrocis medinalis, Parnara guttata, Sesamia inferens, Mythimna separata, Naranga aenescensMoore, Spodoptera litura, Etiella zinckenella, Etiella behrii, Matsumuraeses falcana, Leguminivora glycinivorella, Pleuroptya naafis, Agrotis segetum, Agrotis ipsilon, Helcystogramma triannulellum, Xestia c-nigrum, Helicoverpa assulta, Helicoverpa armigera, Mamestra brassicae, Spodoptera exigua, Plutella xylostella, Pieris rapae, Pieris brassicae, Hellulla undalis, and Autographa nigrisigna.

Examples of the pests belonging to Hemiptera include Nilaparvata lugens, Sogatella furcifera, Laodelphax stratella, Nephotettix cincticeps, Recilia dorsalis, Stenotus rubrovittatus, Trigonotylus caelestialium, Leptocorisa chinensis, Nezara antennata, Nezara viridula, Lagynotomus elongatus, Scotinophara lurida, Eysarcoris annamita, Fysarcoris lewisi, Eysarcoris ventralis, Togo hemipterus Scott, Cletus punctiger, Piezodorus hybneri, Halyomorpha halys, Dolycoris baccarum, Neotoxoptera formosana, Rhopalosiphum padi, Rhopalosiphum maidis, and Aphis glycines.

Examples of the pests belonging to Coleoptera include rice Lissorhoptrus oryzophilus, Oulema oryzae, Echinocnemus squameus, Melanotus legatus, Melanotus fortnumi, Anomala cuprea, Popillia japonica, Maladera castanea, Epilachna varivestis, Paralupcrodes nigrobilineatus, Epilachna vigintioctomaculata, Henosepilachna vigintioctopunctata, Harmonia axyridis, Anomala rufocuprea, Anomala testaceipes, Aulacophora indica, and Phyllotreta striolata.

Examples of the pests belonging to Diptera include Chlorops oryzae, Hydrellia griscola, Sitodiplosis mosellana, Delia platura, Asphondylia yushimai, Melanagromyza sojae, Liriomyza trifolii, Liriomyza sativac, Liriomyza huidobrensis, and Liriomyza bryoniae.

Examples of the pests belonging to Orthoptera include Oxya yezoensis and Oxya japonica. Examples of the pests belonging to Thysanoptera include Stenchaetothrips biformis and Thrips palmi. Examples of the pests belonging to Tylenchida include Meloidogyne, Nematoda, and Heterodera. Examples of the pests belonging to Collembola include Onchiurus psuedamatus yagii and Onychiurus matsumotoi. Examples of the pests belonging to Acarina include Penthaleus major, Tetranychus urticae, Tetranychus kanzawai, Tyrophagus putrescentiae, and Tarsonemus bilobatus. Examples of the pests belonging to Stylommatophora include Helix and Philomycidae. Examples of the pests belonging to Ascaridida include Ascaris lumbricoide. Examples of the pests belonging to Opisthorchiida include Metagonimus yokogawai. Examples of the pests belonging to Strigeidida include Schistosoma japonicum. Examples of the pests belonging to Blattodea include Blattella germanica, Periplaneta fuliginosa, Periplaneta americana, and Blatta lateralis. Examples of the pests belonging to Thysanura include Ctenolepisma and Lepisma.

### Additional Uses

The compositions of the subject invention can be used for a variety of applications including, but not limited to, control of pests in luggage, drainpipes, bednets, baseboards, curtains, and domesticated animals (e.g., dogs, cats, horses, cattle, and sheep), and other subjects. A person skilled in the art, having the benefit of the subject disclosure could formulate the compositions of the subject invention for these and other uses. For example, the compositions can comprise ingredients that cause the active agents to adhere to a desired location and/or surface.

In certain embodiments, the composition is formulated as, for example, an aerosol, cream, foam, gel, lotion, ointment, paste, powder, solid, sponge, tape tincture, tablet, transdermal patch, vapor, spray, skin hygiene/cosmetic product, bait, emulsifiable concentrate, solution, flowable, invert emulsion, dust, granule, tablet, pellet, wettable powder, water-dispersible granule, dry flowable, water-soluble powder, or ultra-low volume fumigant. In certain embodiments, the composition is microencapsulated, in a water-soluble package, or in the form of a ready-to-use sprayable liquid or fumigant.

### Methods of the Subject Invention to Control Pests

In one embodiment, the subject invention provides methods for killing and/or repelling a pest wherein a pest control composition, according to the subject invention, is contacted with the pest or is in close proximity to the pest. The pest can be within, for example, 1 μm, 1 mm, 1 cm, 1 m, 10 m or greater of the repellent composition.

In preferred embodiments, the pest is an arthropod, e.g., an insect pest. The pest can be selected from, for example, mosquitos, flies, beetles, cockroaches, ants, larvae, lice, moths, ticks, fleas, chiggers, leaches, and others that may suck blood, bite or sting. Exemplary arthropod orders can include but are not limited to orders Acari, Anoplura, Araneae, Blattodea, Coleoptera, Collembola, Diptera, Grylloptera, Hemiptera, Heteroptera, Homoptera, Hymenoptera, Isopoda, Isoptera, Lepidoptera, Mantodea, Mallophaga, Neuroptera, Odonata, Orthoptera, Psocoptera, Siphonaptera, Symphyla, Thysanura, and Thysanoptera. In certain embodiments, the mosquitoes are in the families Anophelinae or Culicinae. In preferred embodiments, the mosquito is in the genera Aedes, Culex, Coquillettidia or Anopheles. In one embodiment, the pest is a disease vector.

In one embodiment, the method comprises contacting the composition with clothing, fur skin, bednet, curtain, clothing, bedding, or other surface upon which the pest may traverse, rest, settle, mate, lay eggs and/or feed. In another embodiment, the method comprises applying the composition directly to the pest. In certain embodiments, “applying” and/or “contacting” a surface and/or pest comprises dropping, rubbing, spraying or sprinkling the composition onto the surface, pest, and/or the environment surrounding the surface and/or pest.

In one embodiment, the method can be used for inhibiting, preventing or reducing the spread and/or incidence of pest-borne disease, for example, in plants, humans and animals, by, for example, controlling a disease vector pest.

In one embodiment, the method can be used to control pests that are considered nuisances in the home, garden and/or lawn. For example, the pest control composition can be applied using, for example, a handheld sprayer, to the lawn, garden, and landscaping surrounding a home to, for example, reduce the populations of a pest that might infest such areas and/or that might enter the home undesirably.

In order to reduce the presence of pests in an area of interest insecticides are sprayed upon them directly. Typically, this leads to the insects dying or being incapacitated. After a period of time other pest insects can enter this area of interest. The compositions of the subject invention not only kill the insects in the area of interest but also repel new insects from entering this area for a longer duration. Additionally, the insects in the vicinity that survive because they do not receive a lethal dose will associate the volatile repellent with the toxic effect of the pesticide, and avoid it strongly for periods of time.

A greater understanding of the present invention and of its many advantages may be had from the following example, given by way of illustration. The following example is illustrative of some of the methods, applications, embodiments and variants of the present invention. This is not to be considered as limiting the invention.

### Example 1—Method of Testing Formulations for Improved Pest Control Efficacy Duration

To test the enhanced efficacy of the formulations of the pesticide an arena can be used which includes several nooks, crannies and hiding spots. The formulation to test can be sprayed into the arena with the pesticidal active ingredient in a series of concentrations around the known LD50 concentration. The LD50 and LD90 of the formulations will be compared to that of the pesticide without the repellent.

### Example 2—Method of Testing Formulations for Improved Pest Control Duration

To test the enhanced duration of pest clearance of the formulations after the residual effect of the pesticide has disappeared, a test arena can be used which includes a insect resting zone where a sprayed pesticide does not reach at levels to kill the insects, and at a distance from it a zone of testing, baited with a desirable food/plant. Insects will be released in the arena and the formulation to can be sprayed on the insects present in the baited test zone. Insects in the resting zone are not in contact with insecticide. After a fixed period of time has elapsed during which the insecticidal effect has worn off (1, 2 or 3 days), the test area will be watched for insects from the resting zone entering the baited test zone of interest that we desire to protect. The number of insects entering the test area formulation in the will be compared with the mean numbers in a formulation without the repellents.

We claim:

1. A pest control composition comprising effective amounts of an arthropod killing active compound and a second compound that is an arthropod repellent,
wherein the arthropod killing active compound is selected from CNP0079038, CNP0120904, CNP0173757, CNP0000298, CNP0285570, CNP0412436, CNP0106518, CNP0180805, CNP0382644, CNP0108086, CNP0202290, CNP0203398, CNP0273658, CNP0342741, CNP0183160, CNP0069800, CNP0258229, CNP0400629, CNP0318069, CNP0264889, CNP0131538, CNP0176409, CNP0148322, CNP0144547, CNP0317580, CNP0217844, NPA012598, NPA009464, CNP0210890, NPA027277, CNP0350652, CNP0186174, NPA010389, CNP0363255, CNP0151615, CNP0105906, NPA018066, CNP0275302, NPA018193, NPA007801, CNP0102711, CNP0309377, NPA007306, ZINC95914430, CNP0215473, CNP0257645, NPA017706, NPA018423, CNP0132760, NPA014867, CNP0001094, CNP0366513, NPA004794, CNP0149729, NPA017560, Amb24325948, CNP0401507, CNP0210755, CNP0120027, CNP0172046, CNP0000307, NPA019908, CNP0164761, CNP0392167, CNP0176238, CNP0191380, CNP0252689, CNP0377554, CNP0251537, NPA008658, CNP0000309, CNP0150381, ZINC13378981, CNP0193270, CNP0120219, or any combination thereof; or
selected from pyrethrum, Sodium Lauryl Sulfate, Rosemary Oil, Peppermint Oil, Thyme Oil, Cinnamon Oil, Garlic Oil, Clove Oil, Cedar Wood Oil, 1% Spearmint Oil, Neem Oil, Sumithrin, d-Phenothrin, Prallethrin, Deltamethrin, Fipronil, Hydramethylnon, Hydroprene, Methoprene, Pyriproxyfen, Diatomaceous Earth, d-Phenothrin, N-Octyl Bicyclopheptene Dicarboximide, Imidacloprid, 1% n-Octyl bicycloheptene dicarboximide, Clothianidin, Metofluthrin, (S)-methoprene, Pyriproxyfen, Flumethrin, Selamectin, Dinotefuran, Spinetoram, Fluralenar, Indozacarb, Coumaphos, piperonyl butoxide, cyfluthrin, bifenazate, Aldicarb, esfenvalerate, Bacillus thuringiensis, cyfluthrin, Beta-cyfluthrin, Carbaryl, Carbofuran, Chlorpyrifos, thiamethoxam, dimethoate, malathion, Diazinon, Dibrom 8E, Dimethoate, diflubenzuron, Dipel 2X, Endosulfan, Esfenvalerate, pymetrozine, Gama- and Lamda-cyhalothrin, azinphos methyl, Idoxacard, phosmet, dicofol, methomyl, Malathion, Metasystox-R, Methidathion, Methomyl, Methoxychlor, Methyl parathion, oxydemeton-methyl, Mustang Max, Neemix, Chlorpyrifos, Parathion 4E, Permethrin, Phosmet, Imidacloprid, Pyrethrins, Carbaryl, Telfluthrin, Aldicarb, Terbufos, Endosulfan, hexakis fenbutatin-oxide, Warrior, Etoxazole, Zolone 3EC, Zeta-Cypermethrin, Sulfur Spinosad (spinosyn A and spinosad D), Potassium Salts of Fatty Acids, Bifenthrin, cypermethrin, tebuconazole, tau-fluvalinate, carbaryl, insectidal soap, or any combination thereof.

2. The composition of claim 1, wherein the one or more repellent is from Hydroxycitronellal methyl anthranilate schiff's base, beta-napthyl anthranilate, linalyl anthranilate, Methyl 2-(4-tert-butylphenyl)acetate, 2 isothiocyanatoethylbenzene, Methyl Jasmonate, Ethyl anthranilate, Citrus aurantium flower oil (Neroli extract), Isobutyl Anthranilate, Ivy carbaldehyde/methyl anthranilate schiff's base, Methyl Anthranilate, Butyl Anthranilate, 4-acctoxy-2,5-dimethyl-3 (2h) furanone, Isopropyl anthranilate, Epsilon-Caprolactam, 1-(2,6,6-trimethyl-1-cyclohex-2-enyl) hepta-1,6-dien-3-one, acetyl methyl anthranilate, methyl dihydrojasmonate, 4-methyl cyclohexene, P-tert-butyl-alpha-methylhydrocinnamal/Methyl Anthranilate schiff's base, Phenethyl anthranilate, 2,4-ivy carbaldehyde/methyl anthranilate schiff's base, NR0395222, NR0296309, NR0244708, NR0296386, NR0021218, NR0377154, NR0325443, NR0045428, NR0296302, NR0381679, NR0044159, ZR11, ZR404, ZR243, ZR6, ZR352, ZR135, ZR189, ZR46, ZR52, ZR104, ZR268, ZR492, ZR277, ZR218, ZR403, ZR389, ZR388, ZR146, ZR234, ZR468, ZR35, or any combination thereof.

3. The composition of claim 1, comprising one or more repellent selected from Hydroxycitronellal methyl anthranilate schiff's base, beta-napthyl anthranilate, linalyl anthranilate, Methyl 2-(4-tert-butylphenyl)acetate, 2 isothiocyanatocthylbenzene, Methyl Jasmonate, Ethyl anthranilate, Citrus aurantium flower oil (Neroli extract), Isobutyl Anthranilate, Ivy carbaldehyde/methyl anthranilate schiff's base, Methyl Anthranilate, Butyl Anthranilate, 4-acetoxy-2,5-dimethyl-3 (2h) furanone, Isopropyl anthranilate, Epsilon-Caprolactam, 1-(2,6,6-trimethyl-1-cyclohex-2-enyl) hepta-1,6-dien-3-one, acetyl methyl anthranilate, methyl dihydrojasmonate, 4-methyl cyclohexene, P-tert-butyl-alpha-methylhydrocinnamal/Methyl Anthranilate schiff's base, Phenethyl anthranilate, 2,4-ivy carbaldehyde/methyl anthranilate schiff's base, NR0395222, NR0296309, NR0244708, NR0296386, NR0021218, NR0377154, NR0325443, NR0045428, NR0296302, NR0381679, NR0044159, ZR11, ZR404, ZR243, ZR6, ZR352, ZR135, ZR189, ZR46, ZR52, ZR104, ZR268, ZR492, ZR277, ZR218, ZR403, 7R389, ZR388, ZR146, ZR234, ZR468, ZR35, or any combination thereof and a killing active compound selected from CNP0079038, CNP0120904, CNP0173757, CNP0000298, CNP0285570, CNP0412436, CNP0106518, CNP0180805, CNP0382644, CNP0108086, CNP0202290, CNP0203398, CNP0273658, CNP0342741, CNP0183160, CNP0069800, CNP0258229, CNP0400629, CNP0318069, CNP0264889, CNP0131538, CNP0176409, CNP0148322, CNP0144547, CNP0317580, CNP0217844, NPA012598, NPA009464, CNP0210890, NPA027277, CNP0350652, CNP0186174, NPA010389, CNP0363255, CNP0151615, CNP0105906, NPA018066, CNP0275302, NPA018193, NPA007801, CNP0102711, CNP0309377, NPA007306, ZINC95914430, CNP0215473, CNP0257645, NPA017706, NPA018423, CNP0132760, NPA014867, CNP0001094, CNP0366513, NPA004794, CNP0149729, NPA017560, Amb24325948, CNP0401507, CNP0210755, CNP0120027, CNP0172046, CNP0000307, NPA019908, CNP0164761, CNP0392167, CNP0176238, CNP0191380, CNP0252689, CNP0377554, CNP0251537, NPA008658, CNP0000309, CNP0150381, ZINC13378981, CNP0193270, CNP0120219, or any combination thereof.

4. The composition of claim 1, comprising one or more repellent selected from Hydroxycitronellal methyl anthranilate schiff's base, beta-napthyl anthranilate, linalyl anthranilate, Methyl 2-(4-tert-butylphenyl)acetate, 2 isothiocyanatoethylbenzene, Methyl Jasmonate, Ethyl anthranilate, Citrus aurantium flower oil (Neroli extract), Isobutyl Anthranilate, Ivy carbaldehyde/methyl anthranilate schiff's base, Methyl Anthranilate, Butyl Anthranilate, 4-acctoxy-2,5-dimethyl-3 (2h) furanone, Isopropyl anthranilate, Epsilon-Caprolactam, 1-(2,6,6-trimethyl-1-cyclohex-2-enyl) hepta-1,6-dien-3-one, acetyl methyl anthranilate, methyl dihydrojasmonate, 4-methyl cyclohexene, P-tert-butyl-alpha-methylhydrocinnamal/Methyl Anthranilate schiff's base, Phenethyl anthranilate, 2,4-ivy carbaldehyde/methyl anthranilate schiff's base, NR0395222, NR0296309, NR0244708, NR0296386, NR0021218, NR0377154, NR0325443, NR0045428, NR0296302, NR0381679, NR0044159, ZR11, ZR404, ZR243, ZR6, ZR352, 7R135, ZR189, ZR46, ZR52, ZR104, ZR268, ZR492, ZR277, ZR218, ZR403, ZR389, ZR388, ZR146, 7R234, 7R468, ZR35, or any combination thereof and a killing active compound selected from pyrethrum, Sodium Lauryl Sulfate, Rosemary Oil, Peppermint Oil, Thyme Oil, Cinnamon Oil, Garlic Oil, Clove Oil, Cedar Wood Oil, 1% Spearmint Oil, Neem Oil, Sumithrin, d-Phenothrin, Prallethrin, Deltamethrin, Fipronil, Hydramethylnon, Hydroprene, Methoprene, Pyriproxyfen, Diatomaceous Earth, d-Phenothrin, N-Octyl Bicyclopheptene Dicarboximide, Imidacloprid, 1% n-Octyl bicycloheptene dicarboximide, Clothianidin, Metofluthrin, (S)-methoprene, Pyriproxyfen, Flumethrin, Selamectin, Dinotefuran, Spinetoram, Fluralenar, Indozacarb, Coumaphos, piperonyl butoxide, cyfluthrin, bifenazate, Aldicarb, esfenvalerate, Bacillus thuringiensis, cyfluthrin, Beta-cyfluthrin, Carbaryl, Carbofuran, Chlorpyrifos, thiamethoxam, dimethoate, malathion, Diazinon, Dibrom 8E, Dimethoate, diflubenzuron, Dipel 2X, Endosulfan, Esfenvalerate, pymetrozine, Gama- and Lamda-cyhalothrin, azinphos methyl, Idoxacard, phosmet, dicofol, methomyl, Malathion, Metasystox-R, Methidathion, Methomyl, Methoxychlor, Methyl parathion, oxydemeton-methyl, Mustang Max, Neemix, Chlorpyrifos, Parathion 4E, Permethrin, Phosmet, Imidacloprid, Pyrethrins, Carbaryl, Telfluthrin, Aldicarb, Terbufos, Endosulfan, hexakis fenbutatin-oxide, Warrior, Etoxazole, Zolone 3EC, Zeta-Cypermethrin, Sulfur Spinosad (spinosyn A and spinosad D), Potassium Salts of Fatty Acids, Bifenthrin, cypermethrin, tebuconazole, tau-fluvalinate, carbaryl, insectidal soap, or any combination thereof.

5. The composition of claim 1, wherein the repellent is methyl N,N-dimethylanthranilate.

6. The composition of claim 1, wherein the repellent is methyl anthranilate or ethyl anthranilate.

7. The composition of claim 1, wherein the killing active compound is pyrethrum or permethrin.

8. The composition of claim 1, wherein the killing active compound is cinnamon oil or eugenol or cinnamaldehyde.

9. The composition of claim 1, wherein the repellent is present in the composition at a concentration of about 1% to about 99%.

10. The composition of claim 1, wherein the pesticide is present in the composition at a concentration of about 0.01% to about 5%.

11. The composition of claim 1, wherein a solvent is present in the composition at a concentration of about 30% to about 95%.

12. A method for controlling an arthropod pest, the method comprising applying a pest control composition of claim 1 to the pest and/or its surroundings.

13. The method of claim 12, wherein the arthropod pest is an insect pest.

14. The method of claim 13, wherein the insect pest is a disease vector.

15. The method of claim 12, wherein the insecticide is from CNP0079038, CNP0120904, CNP0173757, CNP0000298, CNP0285570, CNP0412436, CNP0106518, CNP0180805, CNP0382644, CNP0108086, CNP0202290, CNP0203398, CNP0273658, CNP0342741, CNP0183160, CNP0069800, CNP0258229, CNP0400629, CNP0318069, CNP0264889, CNP0131538, CNP0176409, CNP0148322, CNP0144547, CNP0317580, CNP0217844, NPA012598, NPA009464, CNP0210890, NPA027277, CNP0350652, CNP0186174, NPA010389, CNP0363255, CNP0151615, CNP0105906, NPA018066, CNP0275302, NPA018193, NPA007801, CNP0102711, CNP0309377, NPA007306, ZINC95914430, CNP0215473, CNP0257645, NPA017706, NPA018423, CNP0132760, NPA014867, CNP0001094, CNP0366513, NPA004794, CNP0149729, NPA017560, Amb24325948, CNP0401507, CNP0210755, CNP0120027, CNP0172046, CNP0000307, NPA019908, CNP0164761, CNP0392167, CNP0176238, CNP0191380, CNP0252689, CNP0377554, CNP0251537, NPA008658, CNP0000309, CNP0150381, ZINC13378981, CNP0193270, CNP0120219, or any combination thereof.

16. The method of claim 12, used to inhibit, prevent and/or reduce the spread or incidence of pest-borne disease in plants, animals and/or humans.

17. The method of claim 12, wherein the pest control composition is applied to a surface upon which a pest traverses, rests, mates, lays eggs and/or feeds.

18. The method of claim 17, wherein the surface is bedding material, curtains, luggage, fur, or clothing.

19. The method of claim 12, used to control an agriculture pest.
